(19) United States
(12) Patent Application Publication
(10) Pub. No.: US 2012/0189189 A1
(43) Pub. Date: Jul. 26, 2012

(54) OPTICAL INSPECTION OPTIMIZATION

(75) Inventors: Rodney Bryan Doe, Seattle, WA (US); John Strom, North Bend, WA (US); Christopher McLaughlin, Minneapolis, MN (US)

(73) Assignee: Rudolph Technologies Inc., Flanders, NJ (US)

(21) Appl. No.: 13/265,670

(22) PCT Filed: Apr. 22, 2010
(86) PCT No.: PCT/US10/32044

§ 371 Date: Apr. 16, 2012

Related U.S. Application Data
(60) Provisional application No. 61/172,077, filed on Apr. 23, 2009.

(51) Int. Cl. G06K 9/00

(52) U.S. Cl. 382/149; 382/145

(57) ABSTRACT

A method of optimizing an optical inspection and fabrication process is herein disclosed. Images, preferably color digital images, of an object are obtained and multiple filter space representations of these images are created. Each of the representations and the channels or data that define them are analyzed separately or in combination with one another to determine which representations, combination of representations, channels, combinations of channels, data or combinations of data provide the most optimal data for analysis by optical inspection algorithms. The process may be automated in terms of the creation of image representations and/or single or multivariate analysis.

### CROSS-REFERENCE TO RELATED APPLICATION

This application is a U.S. national stage application claiming priority under 35 U.S.C. §371 to International Application Serial No. PCT/US10/32044, filed Apr. 22, 2010, which claims the benefit of U.S. Provisional Application Ser. No. 61/172,077, filed Apr. 23, 2009, the contents of which are incorporated herein by reference.

### TECHNICAL FIELD OF THE INVENTION

The present invention is related to methods for optimizing the optical inspection of objects, in one example a semiconductor device.

### BACKGROUND OF THE INVENTION

Images, whether digital or analog (film based), that are obtained directly from an imaging device tend to be optimized for viewing by humans. While human vision and image processing enjoys many advantages over machine vision, there is much information in images that is not ascertainable to the human eye. Accordingly, it is desirable to optimize images and optical systems used for automated optical inspection to take advantages of the capabilities of machine vision.

### SUMMARY OF THE INVENTION

The present invention relates to a method of optimizing an inspection process. An important step of any inspection process is ensuring that the optimal data or information is used as the basis for an inspection. Accordingly, in one embodiment of the invention, a channel of information concerning an object is identified. The channel of information or channel may be any characteristic of the object that provides a useful inspection result. As most industrial inspection applications are conducted optically, the channel in question is often a selected color or other characteristic that may be derived from an image or a representation of the image or object in one of a number of different color space models. Data needed to generate a channel or to provide the information that defines a channel may be provided by an imaging sensor such as a digital camera. Such an imaging sensor may provide raw data of many types and may provide this raw data to a computer for processing or may be provided with its own controller or processor to provide some level of pre-processing. In some instances therefore, an imaging sensor may be modified to provide an optimal channel of information directly.

A figure of merit is computed to help identify which channel of information will be optimal for the application at hand. While the figure of merit may be any useful function, it is most often correlated with a desired outcome of an inspection process. Some examples of a suitable figure of merit are functions that are correlated with an accuracy or a repeatability of an inspection process. Similarly, as contrast of a image used for inspection purposes may be correlated to a desired outcome of an inspection process, a contrast measure such as an RMS contrast measure may be used as a figure of merit. Other figures of merit may also be used.

As an inspection process is generally intended to have an effect on a physical process or an object, the results of an inspection process are used to identify objects that are of acceptable quality and which therefore should be the subject of additional processing or use. The results of an inspection may also be used to identify objects that should be repaired or scrapped due to the presence of features of interest or defects. In both cases, the inspection process may use at least a portion of the channel of information to obtain useful inspection results.

As the manufacturer of an object such as a semiconductor device is keen to improve the yield of his or her manufacturing process, it is understandable that inspection results obtained through the use of the present invention may be used to modify or adjust an apparatus used in the manufacture or test of an object under inspection. By way of example, if an inspection optimized according to the present invention identifies a source of a defect or unwanted process variation as a chemical mechanical planarization (CMP) tool, the CMP tool may be modified as by replacing a CMP pad so that subsequently processed and inspected objects or devices are improved in quality.

These and other objects, aspects, features and advantages of the present invention will become more fully apparent upon careful consideration of the following Detailed Description of the Invention and the accompanying Drawings, which may be disproportionate for ease of understanding, wherein like structure and steps are referenced generally by corresponding numerals and indicators.

### DESCRIPTION OF THE DRAWINGS

FIG. 1 is flowchart that illustrates an exemplary embodiment of the present invention.

FIG. 2 is an image of an object that is to be optically inspected, in this case a semiconductor device having a number of bond pads formed thereon.

FIG. 3 is a version of the image of FIG. 2 wherein one bond pad has been analyzed to identify a scrub mark thereon using known image processing techniques.

FIGS. 4a-4c are representations of the image of FIG. 2 in filter space, in this case representations of the original RGB image of FIG. 2 in an HSV color space, each of the figures being one of the hue, value and saturation channels, respectively.

FIGS. 5a and 5b are representations of the image of FIG. 4c wherein erode, dilation and thresholding image processing steps have been carried out to clearly identify the probe marks on the bond pads of the semiconductor device.

### DETAILED DESCRIPTION

In the following detailed description of the invention, reference is made to the accompanying drawings that form a part hereof and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

As used herein, the term “filter space” refers to the myriad ways in which an image may be represented for analysis. Filter space encompasses the various color space models used to represent color and grayscale images as well as the various components or channels that make up those representations. Some examples of color space models that are part of a filter space may include but are not limited to CIE and its variants such as CIE 1931 XYZ, CIELUV, CIE-XYZ, CIE-xyY, CIE-uvY, CIELAB, and CIEUVW (CIE 1964); LCHAB; LCHUV; LCHAB; UVW; DIN FSD; Munsell HVC US; PhotoYCC; RGB and its variants such as sRGB, Adobe RGB, and Adobe Wide Gamut RGB (note that RGB color space models are open ended and that by selecting new red, green, blue primaries and a gamma value, new color space models may be readily created); luminance plus chrominance models such as YIQ, YUV, YDbDr, YPbPr, YCbCr, PhotoYCC and xvYCC; hue and saturation models such as HSV, HSB, HSL, HIS or TSD; and CMYK type models, including CMYKOG and CcMmYK. Additional color space models may also be used.

Filter space may also encompass images and representations of images that have been manipulated optically (during image capture) or numerically manipulated through the use of image processing operations based on simple or complex mathematic functions and relationships including, but not limited to Fourier filtering, linear and non-linear filtering, erosion, dilation, convolution, noise reduction, image segmentation, and smoothing. Note that in some embodiments, the fact that one or more of the foregoing image processing steps (or other image processing steps not enumerated herein) have been undertaken for a given image or representation may be used as an input in calculating a figure of merit as described below.

In general, the term “image” refers to a digital image and the term “representation” or the phrase “representation of an image” refers to a counterpart of an image in filter space. Images and representations of an image in filter space may not all include the same data or even be fungible with one another (for example conversion from CMYK to RGB may result in information loss), however they are all representative of the object that was imaged and in most embodiments both images and representations thereof are assessed together according to the present invention. Standard off-the-shelf color space converters such as Color Science Library Version 2.0 may be used to rapidly create multiple representations of an image in filter space. In most embodiments, the capture of images, image processing, the computation of figures of merit or scoring, and the assessment figures of merit or scores to select an optimal representation or channel are carried out electronically by one or more software programs that operation on a controller or computer. Standard input devices such as a keyboard and mouse, cameras or sensors, and memory devices may provide information to the controller or computer for processing. The controller or computer may be a standalone device such as a personal computer or may be a purpose built computational device that forms part of an industrial inspection system such as those marketed by Rudolph Technologies, Inc. of Flanders, N.J. In any case, image and object information is obtained from physical things and all computations are carried out on physical computation devices. The results of present invention are subsequently used to optimize or modify physical processes that are applied to physical objects such as semiconductor devices.

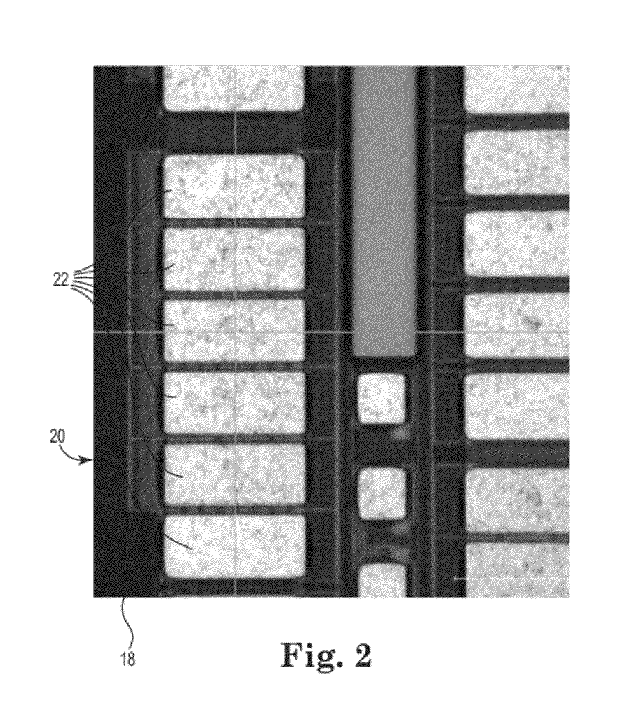

Inspection systems are well known in the art of semiconductor inspection and metrology and in other fields. During inspection an image 18 (FIG. 2) of an object is captured using an imaging system of a known type (not shown). Examples of some suitable imaging systems may include a line scan sensor, a TDI line scan sensor, and area scan sensor such as a CCD or CMOS sensor. Note that other suitable imaging systems have been omitted for the sake of brevity; this disclosure is not to be limited to just those sensors listed here. In one embodiment, the object being imaged is a semiconductor device. In the image 18, the object being imaged is a gold bond pad 22 of a semiconductor device 20. This example is not to be considered as limiting and other objects such as entire semiconductor devices or other substrates may be the subject of the present invention. It is preferable to capture a full-color image so as to maximize the amount of information contained in the image. But, while multi- or full-color images are preferred, monochromatic images and/or images that comprise only certain selected wavelengths may be obtained and put to good use by themselves or in combination with data from other such images.

A digital image may be represented in a generic fashion by the function a(x,y,z,t,λ) wherein the function represents an amplitude a at spatial coordinates x, y, z, time t (where the image or the sampling of an image is time dependent), and wavelength(s) λ. In the context of a digital image, the x, y, z information will often refer to a single pixel in an array of pixels that make up the digital image. In lieu of x, y, z position information, pixels may be located by providing their column and row positions, e.g. (1,1) for the pixel located in the position that is the intersection of the first column and the first row of a 2D array of pixels.

Other information or metadata associated with the image such as polarization states of light may also be included in the representation of an image. Where an image is essentially static, the time value may be omitted. Note that as described above, wavelength and hence color may be specified in a number of manners, including as a combination of a number of component wavelengths. In image processing, the factors that define a color or other characteristic of an image are sometimes referred to as “channels”. One example of a channel is that information relating to the intensity of the color red in an image obtained from a CCD camera sensor that is, as a result of a band pass filter, sensitive only to red light. In this example the red channel consists of an intensity of the red light sensed by the camera. The term “channel” may be used herein to refer directly to the data and values that makes up the channel.

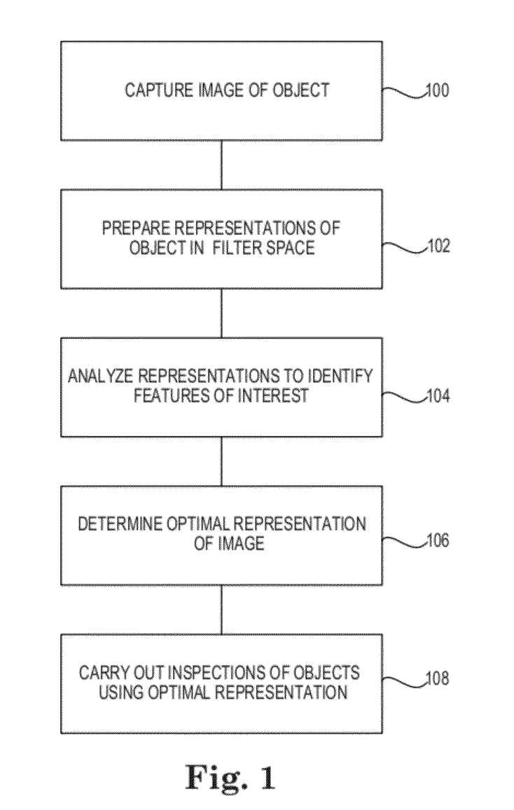

Once an image has been captured as at step 100 in FIG. 1, the captured image is represented in filter space as shown at step 102. This may be accomplished by simply making multiple copies of the image in question and representing each copied image in a selected filter space. Filter space may include any useful number of representations of an image of an object. In one embodiment, a user of an imaging system may select from a number of representations that the user has found in the past to be useful in terms of obtaining useful results. In another embodiment, a fairly exhaustive list of filter space alternate representations of an image of an object may be generated, the list being limited only by computing power, time available to the user and the information contained in the image obtained in step 100. In a particular example of the present invention, a user generates a representation of an image of an object in an HSV color space, the original image being an RGB digital image output by a color camera (three-chip, Bayer or the like). In another embodiment, alternate representations of an image may be automatically generated in each of the color spaces listed above. Note that the manipulation of images is generally performed using a computer that operates software for image analysis and modification. Digital images from a digital camera or a digital image scanner are processed by a computer running image processing and analysis software. Examples of software that may be used to modify an image for the purpose of creating one or more representations in filter space of an image include, but are limited to, MATLAB, Image Pro, Photoshop, GIMP, PaintShop Pro, Color Science Library and ImageJ. The process of creating a representation of an image may be automated (i.e. scripted) or manual.

Once one or more representations of an image are obtained, they can be analyzed to identify which channels of the one or more representations might be useful for a user's end purposes, such as the inspection of semiconductor devices to determine whether features of the devices are within specification and or to identify process variation that is out of specification or which signals a condition that must be remedied. Generally speaking, a figure of merit is computed for each channel of one or more representations, or for a combination of one or more channels from one or more representations. The figure of merit is then used to identify an optimal channel or combination of channels for a user's end purpose. Note that assessing which figure of merit represents an optimal approach to an inspection process may or may not be determinative. In some embodiments, if the figure of merit is appropriately selected, an optimal solution may be obtained by simply selecting the numerically larger figure of merit “score”. In other embodiments, the figure of merit may be used to rank the utility of a selected channel or combination of channels with the understanding that the highest score may not be the optimal choice. In these embodiments, if the figure of merit is well understood, a user may select a range of figure of merit scores that are acceptable and then select the one or more channels or combinations of channels that satisfy that criteria. In some other embodiments multiple figures of merit may be computed, in which case an optimal approach may be selected based at least in part on the multiple figure of merit scores. Boolean or fuzzy logic may be applied to the multiple figure merit scores to identify an optimal channel or combination of channels.

In any given analysis (104) and assessment (106) process, it is possible to assess each of the n channels of information obtained from an image and its m representations provided that have been generated. But given that the number of permutations possible with n channels of information, experience of a user and/or the availability of resources (e.g. computer time) will militate for a relatively small set of likely combinations of the n channels of information that are provided for analysis and comparison.

In one embodiment an appropriate figure of merit(s) may be the outcome of an analysis (104) involving the optical inspection of an object using various channels from an image and/or representations of the object. Optical inspections of this sort may be carried out using inspection algorithms that assess only a single characteristic (channel) of an image or representation, e.g. pixel intensity or saturation values, or using algorithms that consider multiple characteristics (channels) of one or more representations, i.e. both pixel intensity and saturation values. In embodiments such as this, a suitable figure of merit may be the number of defects or features of interest that are found. Where the number of defects or features is known before this analysis 104 takes place, the optimal arrangement of representations, channels or some combination of either or both of these may be the one that most correctly or accurately identifies the number of defects or features of interest that exist. Another figure of merit might be the repeatability of an inspection process that uses inputs from a given representation, channel or combination of either or both. Repeatability is a measure of the consistency of the results of an inspection process. Accuracy and repeatability are sometimes embodied in a count of false positive and false negative results, i.e. how often does an inspection report the presence of a defect or feature of interest when such defects or features are not present and vice versa. Because in some instances repeatability may be more important than accuracy and vice versa, one can readily appreciate that even though a figure of merit computation specified a priori may identify a clear “winner”, a user may select a representation other than the “winner” as being the optimal solution. This makes sense as an inspection process must provide results that are acceptable to a user of the inspection system and where the criteria for what is considered acceptable change, the user of the system must be able to modify how the system operates to obtain an optimal or acceptable outcome.

One example of an inspection algorithm useful with the present invention is described in U.S. Pat. No. 6,324,298 to O'Dell et al. which is jointly owned with the present application and hereby incorporated by reference. Another useful inspection algorithm is described in U.S. Pat. No. 7,102,368 to Strom et al. which is also jointly owned with the present application and hereby incorporated by reference. Inspection algorithms may be used to analyze a representation/image to identify known features. In the case of semiconductor devices, known defects on a device may be identified as by using a pre-inspected substrate or by using a substrate that has known features formed thereon. A quantitative score (figure of merit) may be assigned to determine how well a given algorithm can find a known feature of an object, e.g. the percentage of times that an algorithm can find a given defect or feature in a given representation of a semiconductor device may be quantified. Such scores may be compared to identify (106) which combination of algorithms and filter space representations of an image are optimal for a user's purposes. A user may then select a filter space representation that provides the best inspection results.

It is also possible to analyze individual channels of an image or representation in filter space to determine if the information derived therefrom may be useful; this may be done in lieu of using an inspection algorithm to measure utility. In one embodiment, the contrast provided by channel of an image and its representation are individually assessed to compute a figure of merit based at least in part if not entirely on a contrast measure of all or selected parts of the image and its representations. Note that in general efficiency dictates that where only selected parts of an object are to be inspected only those parts of the object found in an image and its representations will be assessed.

Contrast may be thought of as a difference in a value or characteristic of an image between two areas of the image that allows one to distinguish between those areas or to distinguish those areas from the background of the image. As contrast may be measured or calculated in many ways, the examples provided herein should not be considered to limit the methods or modes one skilled in the art may use to measure contrast in the course of implementing the present invention.

In one embodiment, contrast may be measured by dividing a difference in a channel value as between two areas (as between two pixels or areas of a representation) by an average of the channel value over a larger area that contains the areas used to calculate the difference. As an example, one might determine a measure of contrast by finding the difference between two greyscale intensities and dividing the difference by the average greyscale intensity over an area that encompasses the sub-areas from which the intensity values used to calculate the difference were derived. Note that it is important to select the appropriate areas for this measure to work. For example, one may select a feature in an image or representation and a background area nearby to obtain a difference and divide this by an average value. Multiple such area selections may be made to obtain a statistically significant measure of contrast. This technique is also referred to as RMS contrast which is calculated using the equation:

$$\sqrt{\frac{1}{MN} {\sum }_{i = 0}^{N - 1} {\sum }_{j = 0}^{M - 1} {( {I}_{ij} - \overline{I} )}^{2}} ,$$

In this equation Iᵢⱼ is a spatially distinct intensity or other value and Ī is an average of intensity or other value over an area having the dimensions M×N. Other techniques that may prove useful in quantifying contrast for an image or representation are the Weber contrast measure and the Michelson contrast measure. Additional techniques for computing contrast of an image which may be useful are described or referenced in “Image Enhancement Using a Contrast Measure in the Compressed Domain” by Tang et al., IEEE Signal Processing Letters, Vol. 10, No. 10, October 2003.

Contrast may also be compared as between two images or representations. These channels and data, taken alone or in combination with one another may, in some instances render more useful results to a user. In some instances, a channel from a representation may be analyzed alone, e.g. the blue channel only of an RGB color space representation may be analyzed. In other instances, the channels and data of a first representation may be combined for analysis, e.g. the red and green channels only of an RGB color space representation may be analyzed together. The combination of two or more channels from one or more representations may be a simple mathematic combination, as where the channel values are simply added to one another. Where appropriate, one may also combine channel data in a conditional manner, i.e. may use a first channel where a first set of user imposed criteria are met and use a second channel where the first set of user imposed criteria are not met. Alternatively, multiple sets of criteria may be imposed on the use of channel data. It may also be useful to combine channels in a weighted manner wherein prior to combination, the information from one or more channels are multiplied by a static or dynamic weighting factor that is based at least in part on the correlation of the selected channel to a condition or object that is the subject of an inspection. For example, using the hue channel of an HSV representation may not be particularly useful where the corresponding values derived from the saturation channel of this representation are relatively low. This is because hue values become inherently more variable when saturation values are low. Accordingly, one may assign a lower value to a weighting factor that Modifies a value from a hue channel where a corresponding value from the saturation channel is low.

Accordingly, one may compute and compare contrast values or other figures of merit for one or more channels from one or more representation(s) or images under analysis. Analysis techniques such as regression (single variable or multivariate) may also be used to optimize one or more figures of merit computed using either an inspection algorithm or a measure of contrast or other image based function. In the end, the one or more channels of one or more representations of an image that provides the most appropriate contrast or figure of merit score may be selected for use. Note that the highest contrast or figure of merit score is not always the most appropriate choice for a given application. For example, some very high contrast representations may omit useful or necessary information from an image. However, a user may specify, either a priori or after review of analysis results, a minimum level of contrast that provides the information needed by the user.

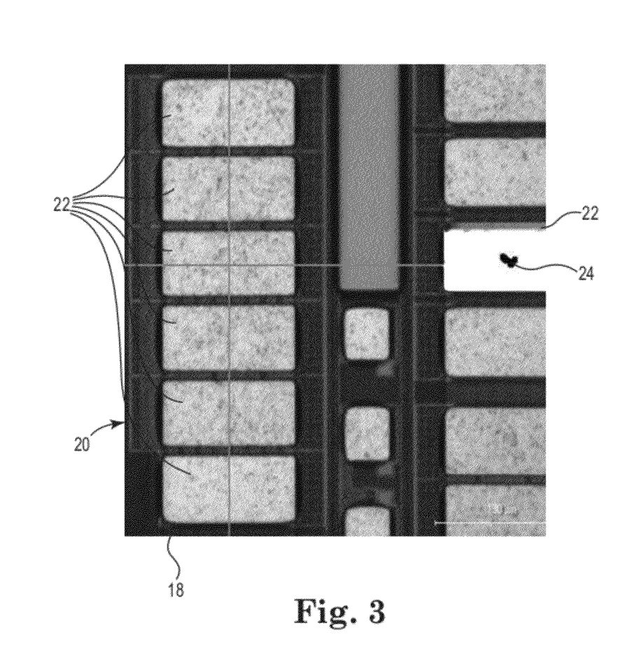

In one embodiment, an image 18 of a semiconductor device 20 having a number of bond pads 22 made of gold is obtained (step 100). Note that the pictured bond pads 22 have a relatively blotchy surface and that each of the pictured bond pads 22 also has a scrub mark formed therein. Unfortunately, scrub marks are hard to discern on the surface of the bond pads 22 as the blotches on the bond pads 22 tends to be of the same size, shape and intensity as scrub marks. A comparison between FIG. 2 and FIG. 3 highlights the difficulty in localizing a scrub mark. In FIG. 2 one cannot easily discern the size and location of a scrub mark in middle bond pad 22 of the right column of bond pads 22. As seen in FIG. 3, however, image processing steps have highlighted the size and location of the scrub mark 24. Accordingly, one may say that the contrast between the blotches on the bond pad and the scrub mark 24 on a bond pad 22 is in the image 20 too low to distinguish the one from the other, at least based solely on the original RGB image. This lack of contrast may render an optical inspection by machine vision or by human eye quite difficult.

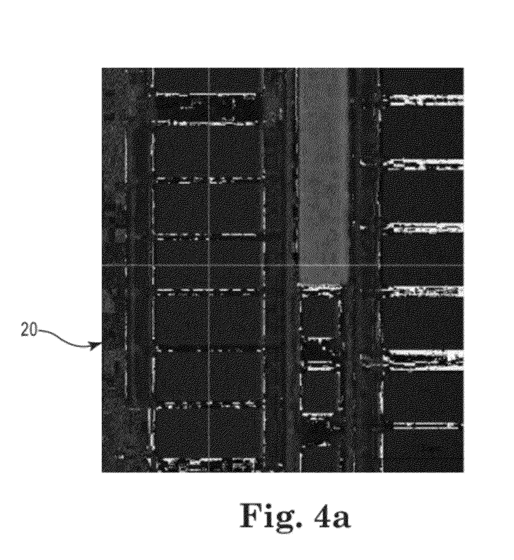

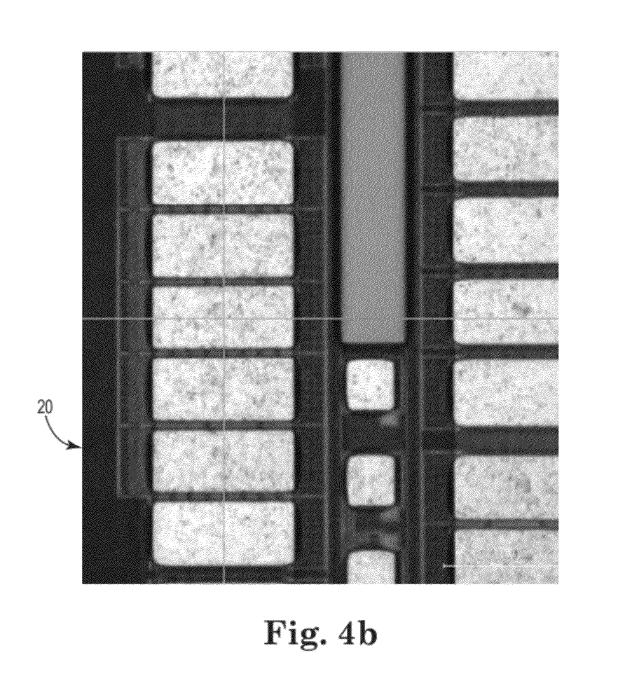

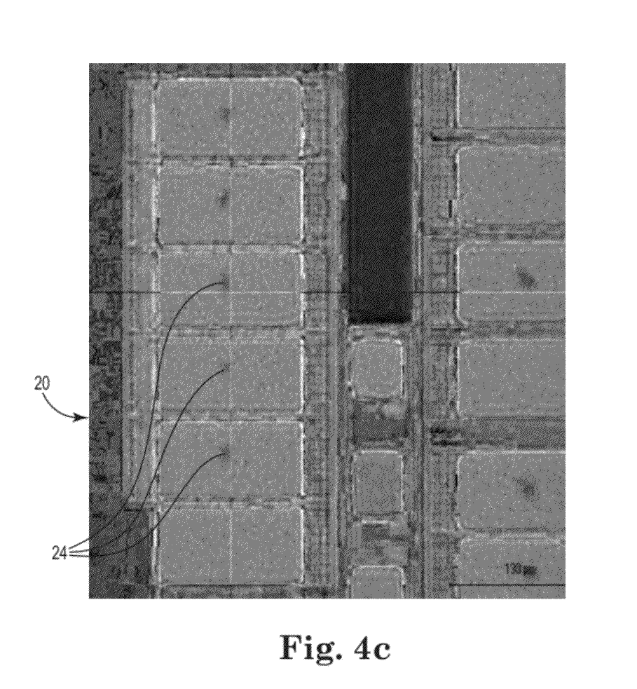

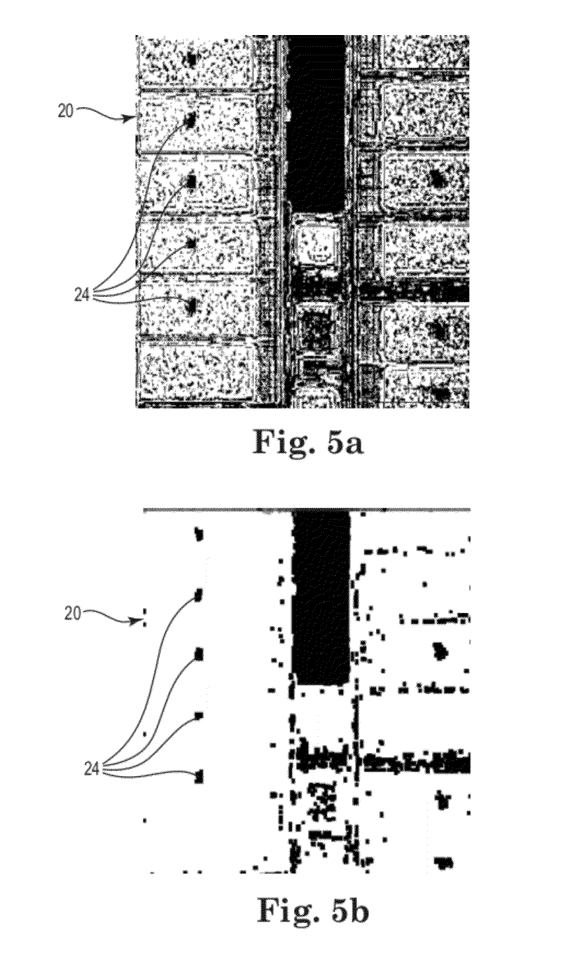

As seen in FIGS. 4a-4c, to identify scrub marks 24, if any, on bond pads 22a, the RGB image of the semiconductor device was duplicated and the duplicate was converted to an HSV color space representation. As seen in FIG. 4a, the hue channel of the HSV color space representation is quite dark and the contrast is such that scrub marks, if any exist on bond pads 22, are not visible. In FIG. 4b, the value channel of the color space representation provides good contrast overall, but does not reveal the presence, if any, of scrub marks 24 on bond pads 22. In FIG. 4c, the saturation channel or component of the HSV color space representation clearly shows the presence of scrub marks 24 on bond pads 22. In FIG. 5a, the saturation channel image is shown after a threshold filter is applied. FIG. 5b shows the saturation image of FIG. 5a after the application of erosion and dilation image processing steps. The scrub marks 24 are clearly visible.

In the example illustrated in FIGS. 4 and 5, the optimal filter space representation of the image of the semiconductor device 20 is an image formed from the saturation channel or component of an HSV color space representation of the semiconductor device 20. In some embodiment one may make a determination based solely on the saturation channel as a figure of merit based on a contrast measurement of each of the bond pads 22 would show that as compared to the hue and value channels, the saturation channel provides a more optimal representation for inspection. But as shown in FIGS. 5a and 5b, one may apply image processing steps to a channel to obtain more definitive information before a figure of merit for that channel is computed. As can be appreciated, a figure of merit based on either a contrast measure or on the reliable localization of scrub marks (i.e. on the outcome of an inspection algorithm) will be different than a figure of merit based solely on the saturation channel of an HSV representation. Where the figure of merit is computed after the application of image processing steps such as erosion and dilation, it can be said that these image processing steps have been accounted for or included in the computation of the figure of merit.

One application of the assessment process described hereinabove is in the fabrication of semiconductor devices such as computer chips. One skilled in the art will readily appreciate that using the method described above, one may obtain better results from an inspection. In turn, the better results of the inspection may identify problems that have cropped up in a fabrication process and which require modification. Making modifications to the process steps in a fabrication process will have real world effects on the production of the semiconductor devices in that the yield of the fabrication process will rise.

By way of example, where a bond pad 22 has a scrub mark 24 that is within a predetermined range of sizes and is located within a predetermined range of locations within the boundaries of the bond pad 22, then a probing process used to electrically test the semiconductor device will be considered to be acceptable will remain unchanged. However, where a scrub mark 24 is located beyond the boundaries of a bond pad 22 or is too large or too small or is otherwise determined to be outside of the specifications for a scrub mark 22, the probing process or a probe card used to carry out the process may be modified. In the instant example, indicated modifications may typically involve the physical repair of one or more probes of a probe card or the modification of the physical alignment of a probe card with respect to the semiconductor device to which a probe card is addressed. Similarly, the presence or absence of material or features on or within a semiconductor device may also warrant changes in a semiconductor device fabrication process. For example, the presence of scratches on the surface of a semiconductor device may require the modification of a chemical-mechanical planarization (CMP) process that operates on a semiconductor device. In this example, indicated modifications may include replacement of a CMP pad or the modification of the pressure applied by a CMP pad on a semiconductor device. The method of the present invention is part of a closed loop system, a result of the application which being that a physical process that acts upon a semiconductor device or other object is modified, thereby modifying the semiconductor device or other object that is acted upon by the physical process.

### CONCLUSION

Although specific embodiments of a method of optimizing an inspection process have been illustrated and described herein, it is manifestly intended that this invention be limited only by the following claims and equivalents thereof.

What is claimed is:

1. A method of improving yield in a manufacturing process comprising:
capturing an image of an object comprising at least color information and intensity information;
creating a plurality of representations in filter space of the object from the captured image;
inspecting the object using at least one channel from each of the plurality of representations of the object;
scoring the inspections carried out on the plurality of representations to identify an optimal representation;
inspecting successive objects using the optimal representation; and,
modifying a physical processing step that acts upon the object based on the results of the inspection of the successive objects using the optimal representation.

2. The method of claim 1 wherein the creating a plurality of representations in filter space of the object from the captured image is carried out automatically by a computer running image processing software.

3. The method of claim 2 further comprising specifying a set of desired representations in filter space.

4. The method of claim 1 wherein the scoring step involves assessing at least one of a false positive or a false negative reporting rate with respect to a known feature of an object.

5. A method of inspecting an object comprising:
obtaining an image of the object, the image being defined by at least one channel;
computing a figure of merit based on at least one channel;
identifying an optimal channel based at least in part on the figure of merit;
performing an inspection on subsequent objects to identify defects or process variation, if any;
modifying the operation of a process tool to modify a subsequent object.

6. The method of claim 5 wherein the image is obtained from a sensor selected from a group consisting of a digital area scan camera, a digital line scan camera, and a digital time delay integration (TDI) camera.

7. The method of claim 5 wherein the image comprises a digital image represented in a color space model selected from a group consisting of CIE, CIE 1931 XYZ, CIELUV, CIE-XYZ, CIE-xyY, CIE-uvY, CIELAB, CIEUVW (CIE 1964), LCHAB, LCHUV, LCHAB, UVW, DIN FSD, Munsell HVC US, PhotoYCC, RGB, sRGB, Adobe RGB, Adobe Wide Gamut RGB, YIQ, YUV, YDbDr, YPbPr, YCbCr, PhotoYCC, xvYCC, HSV, HSB, HSL, HIS, TSD, CMYK, CMYKOG, and CcMmYK.

8. The method of claim 7 further comprising:
generating a plurality of representations of the image, each representation of the image using a different color space model.

9. The method of claim 5 further comprising:
generating at least one representation of the image, each representation of the image being differentiated by at least one distinct channel.

10. The method of claim 9 further comprising:
computing a figure of merit for each of at least two channels selected from a total number of channels defined by the image and the at least one representation.

11. The method of claim 10 wherein the figure of merit is a measure of the accuracy of an optical inspection algorithm.

12. The method of claim 10 wherein the figure of merit is a measure of the repeatability of an optical inspection algorithm.

13. The method of claim 10 wherein the figure of merit is a measure of the contrast of a region of the object.

14. The method of claim 10 wherein the figure of merit is based on a single channel.

15. The method of claim 10 wherein the figure of merit is based on at least two channels.

16. The method of claim 5 wherein the inspection on subsequent objects is performed using data obtained from a single channel.

17. The method of claim 5 wherein the inspection on subsequent objects is performed using data obtained at least two channels.

18. The method of claim 5 wherein the inspection on subsequent objects is performed using data obtained at least two channels.

19. The method of claim 5 wherein at least the computing and identifying steps are performed using a computer that is programmed with appropriate software.

20. A product produced according to the method of claim 5.

21. A method of optimizing an inspection process comprising:
identifying in a set-up process a channel of information concerning an object under inspection that is defined by an optimal figure of merit;
modifying an inspection system comprising an imaging sensor for capturing an image of an object under inspection to provide at least a portion of the channel of information;
inspecting the object under inspection using the channel of information as at least one input of an inspection algorithm for identifying a feature of interest on the object under inspection, if any; and,
modifying an apparatus based at least in part on a result of the inspection of the object under inspection, an aspect of the apparatus that is to be modified being at least partially correlated with the presence of the feature of interest on the object under inspection.

22. The method of optimizing an inspection process of claim 21 wherein the modification of the apparatus results in a reduced presence of the feature of interest in at least one subsequent objects inspected after the modification of the apparatus.

23. The method of optimizing an inspection process of claim 21 wherein the channel of information is a channel of a color space representation of the object.

24. The method of optimizing an inspection process of claim 23 wherein the channel of information is selected from one of a group consisting of a greyscale intensity value, a red value, a blue value, a green value, a hue value, and a saturation value.

25. The method of optimizing an inspection process of claim 21 wherein the figure of merit is a value correlated to at least one of an accuracy and a repeatability of an inspection process.

26. The method of optimizing an inspection process of claim 21 wherein the object under inspection is a semiconductor device.

27. The method of optimizing an inspection process of claim 21 wherein the object under inspection is a bond pad of a semiconductor device and the channel of information is a hue value.
